(19) United States
(12) Patent Application Publication
(10) Pub. No.: US 2003/0054841 A1
(43) Pub. Date: Mar. 20, 2003

(54) Webnum enabled telephones

(76) Inventors: Timothy J. Griswold, Herndon, VA (US); Troy Hickok, Purcellville, VA (US); Mark Fruehan, Allen, TX (US)

Correspondence Address: KENYON & KENYON, 1500 K STREET, N.W., SUITE 700, WASHINGTON, DC, 20005, US

(21) Appl. No.: 10/237,595

(22) Filed: Sep. 10, 2002

Related U.S. Application Data
(60) Provisional application No. 60/317,941, filed on Sep. 10, 2001.

(51) Int. Cl. H04Q 7/20; H04M 1/00; H04B 1/38

(52) U.S. Cl. 455/460; 455/564

(57) ABSTRACT

A device such a cellular telephone is provided with an I-key. A register of the telephone is used to stored the digits entered on the keypad of the phone. If the I-key is pressed after a sequence of digits has been entered on the keypad, the phone interprets the number in the register as an private number for an information resource such as are available on the Internet. The phone translates the private number into an URL, and obtains a TCP/IP address corresponding to the URL. The phone transmits an access request to the Internet resource corresponding to the private number and launches a browser or another suitable application to display the data returned from the resource.

This application is related to or derived from the following U.S. provisional patent applications, each of which are incorporated by reference: Serial No. 60/308,602 (VOICE NAVIGATION SERVICE, filed on Jul. 31, 2001); Serial No. 60/225,647 (NUMERIC/VOICE NAME INTERNET ACCESS ARCHITECTURE AND METHODOLOGY, filed on Aug. 16, 2000); Serial No. 60/231,576 (PRIVATE NUMBERING SYSTEM, filed on Sep. 11, 2000), and Serial No. 60/256,325 (WEBNUM TECHNICAL SPECIFICATION EXTENDED WEBNUMS CC WEBNUMS AND POWER WEBNUMS, filed on Dec. 19, 2000). This application claims the benefit of U.S. provisional patent application Serial No. 60/317,941 WEBNUM ENABLED TELEPHONES, filed on Sep. 10, 2001, which is incorporated by reference herein.

### BACKGROUND

Accessing Internet resources over a phone is a cumbersome and multi-step process. The phone user is typically required to invoke a web browser and choose an Internet access point before the uniform resource locator (URL) of the Internet resource to be accessed can be entered. Furthermore, even the entry of the URL is cumbersome, since the user must use a tap code process to enter an URL using a standard 12-key phone keypad.

By contrast, phone calls can be easily established. For example, on a wireless phone, the user merely enters the telephone number and then hits the “send” key.

### SUMMARY

In accordance with a preferred embodiment of the invention, a phone is provided which includes an I-key that supports a private numbering system for access to resources on one or more networks, such as the Internet. An example of an I-key is an Internet key that can be used to access resources located on the Internet. Other examples of an I-key include a LAN-key for accessing resources on a Local Area Network (LAN); a WAN-key for accessing resources on a set of interconnected LANs and/or a Wide Area Network (WAN); etc. The private numbering system can allow users to specify Internet Web sites (as well as other types of Internet resources) by entering a sequence of digits instead of a text URL. Private numbering systems may be supported by remote databases which map the numbers to URLs, and the URLs to TCP/IP addresses and ports, thereby permitting the private number to be used as a pointer to an Internet resource.

Preferably, to access an Internet resource, the user enters a private number using the standard 12-key telephone keypad and then presses an Internet key on the phone. When the Internet key is pressed, the phone invokes its Internet browser and processes the private number by sending it to a special database on a system that is accessible over the Internet. The database maps the private number to an Uniform Resource Locator (URL). The host name would subsequently be resolved through the Internet Domain Name System (DNS) to an IP address to identify the IP address of the Internet resource. An Internet Service Provider (ISP), which in the case of a cellular phone, may be the cellular phone provider, would be used to send an access request to the Internet resource. Data returned by the Internet resource would be sent via the ISP and to the phone provider and then over the phone network to the phone.

Alternatively, the user may press the Internet key without first entering a private number. In this case, the phone will access a default Internet resource. This may be, for example, a Web page of the phone carrier, a Web page corresponding to a portal, or a default home page chosen by the user.

### BRIEF DESCRIPTION OF THE DRAWINGS

The foregoing and other advantages and features of the invention will become more apparent from the detailed description of the preferred embodiments of the invention given below with reference to the accompanying drawings in which:

FIG. 1 is an illustration of a phone in accordance with a preferred embodiment of the invention;

FIG. 2 is a block diagram of the phone of FIG. 1;

FIG. 3 is a flowchart illustrating the operation of the phone of FIG. 1;

FIG. 4 is an illustration of the WebNum private number system; and

FIG. 5 is an flow chart illustrating the operation of the WebNum private number system.

### DETAILED DESCRIPTION

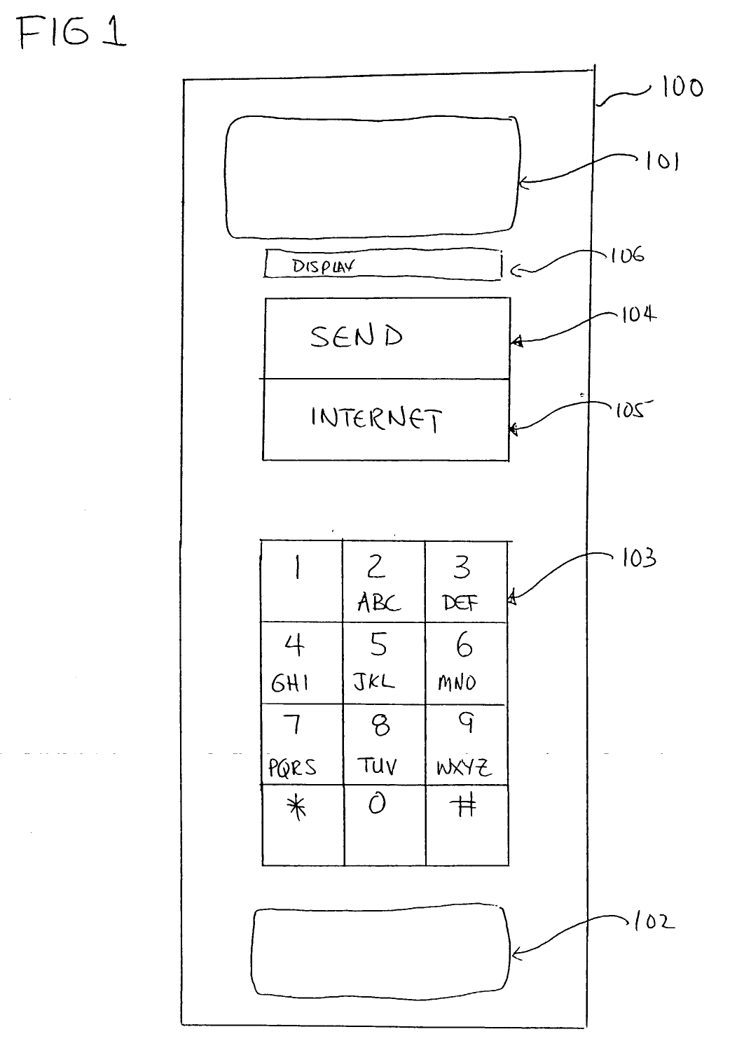

Now referring to the drawings, where like reference numerals designate like elements, there is shown in FIG. 1, a phone 100 in accordance with a preferred embodiment of the invention. The phone 100 preferably includes an ear piece 101 and a mouth piece 102 to support voice communications. The phone 100 also includes a standard 12-digit keypad 103, a Send key 104, an Internet key 105, and a display 106. In a preferred embodiment, the phone 100 is a wireless phone, for example, a cellular phone. However, alternative embodiments may include implementation in wired phones or any other communication device.

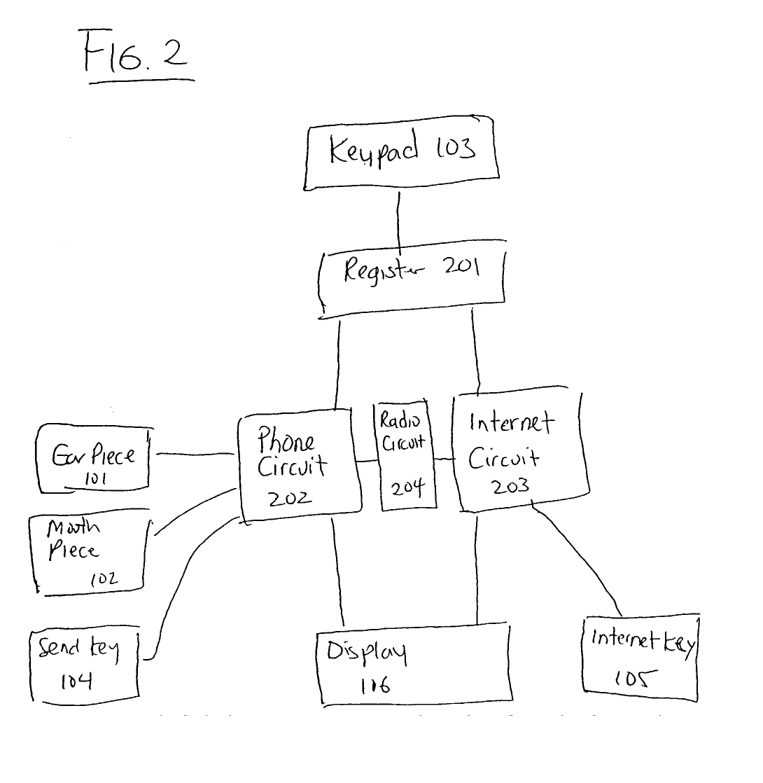

FIG. 2 is a functional block diagram of the phone 100. The keypad 103 is coupled to a register 201. The register 201 is coupled to both the telephone circuit 202 and the Internet circuit 203. It should be noted that while FIG. 2 illustrates telephone circuit 202 and Internet circuit 203 as separate circuits, both circuits may be combined into a single circuit. Additionally, while telephone circuit 202 and Internet circuit 203 are illustrated as circuits, they may also be implemented as one or more software/hardware combinations, or as one or more software routines which executes on a processor of the phone 100. If the telephone 100 is a wireless phone, such as cell phone of the preferred embodiment, the telephone 202 and Internet 203 circuits are each also coupled to a radio circuit 204. The telephone circuit 202 supports phone calls and is therefore coupled to the ear piece 101, the mouth piece 102, and the send key 104. The Internet circuit 203 supports Internet access and is coupled to the Internet key 105. Both the telephone 202 and Internet 203 circuits are also coupled to the display 106.

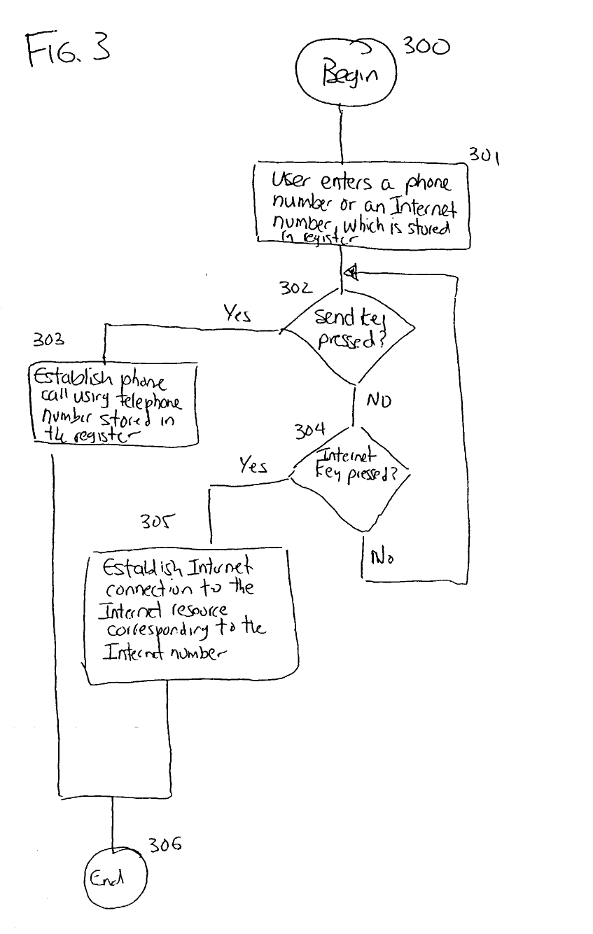

FIG. 3 is a flow chart which illustrates an exemplary operation of the phone 100 at steps 300-306. At step 301, the user enters a sequence of digits corresponding to either a telephone number or an Internet private number via keypad 103. The sequence of digits are stored in register 201. Alternatively, if the phone 100 supports a telephone directory, instead of the user entering a sequence of digits from the keypad 103, the user may retrieve a number from the directory. In some instances, the directory may include data not compatible with telephone numbers and/or private numbers. These may include characters such as “+” symbols, space characters, etc. Characters which are not compatible may be stripped so that only the numeric digits and the “*” and “#” symbols may be stored in the register 201. Alternatively, the phone directory data may contain entries which include alphabetic characters. Alphabetic characters may be mapped into numeric digits using the mapping printed on conventional 12-key telephone keypads (for example, A,B,C maps to 2; D, E, F maps to 3; G, H, I maps to 4; J, K, L maps to 5; M, N, O maps to 6; P, Q, R, S maps to 7, T, U, V maps to 8, and W, X, Y, Z maps to 9). An entry which contains alphabetic characters will have those alphabetic characters mapped to numeric digits before the entry is stored in the register 201.

At step 302, if the Send key 104 has been pressed, execution continues at step 303. Otherwise execution continues at step 304. At step 303, the phone circuit 202 establishes a phone call using the digits stored in register 201 as a phone number. If the phone is a wireless phone, the phone call is established via radio circuit 204. Execution then ends at step 306.

If the Send key 104 was not pressed at step 302, execution continues at step 304, which checks whether the Internet key 105 has been pressed. If the Internet key 105 was pressed, then execution continues at step 305. If the Internet key was not pressed, execution resumes at step 302. At step 305, the Internet circuit establishes an Internet connection using the digits stored in register 201 as a private number.

The Internet connection is established by sending the private number, via an Internet Service Provider (ISP), for example, the phone provider, to a remote database which maps the private number onto an URL. The host name portion of the URL can then be translated into a TCP/IP address by sending a request to a domain name (DNS) server, such as a DNS server of the ISP. The access type and port number can be identified from the URL itself. The Internet circuit 203 then sends the appropriate access request to the resolved TCP/IP address and port via the ISP. The Internet circuit 203 also invokes a Web browser to display the data returned by the access request. Alternatively, if the Internet resource being accessed is not a web page, the Internet circuit 203 may launch other appropriate software to interact with the data being returned. For example, if the accessed resource is an Internet Relay Chat (IRC) server, the Internet circuit 203 may launch an IRC client.

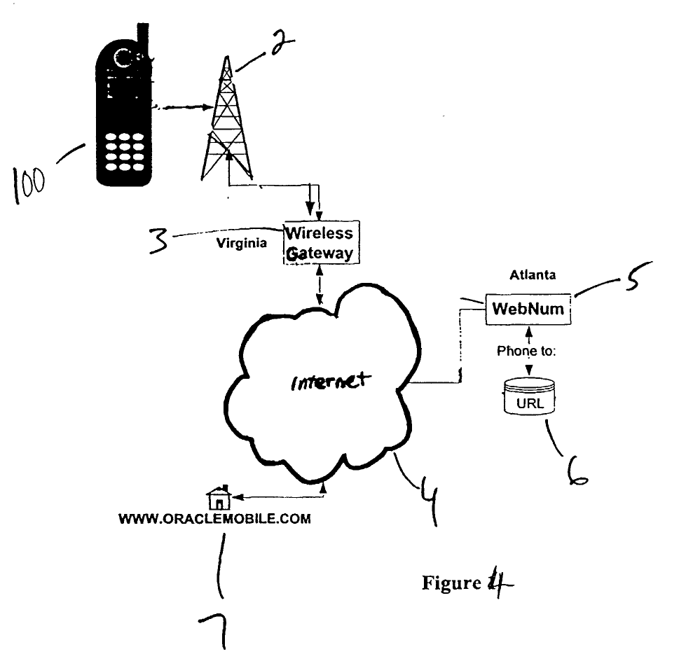

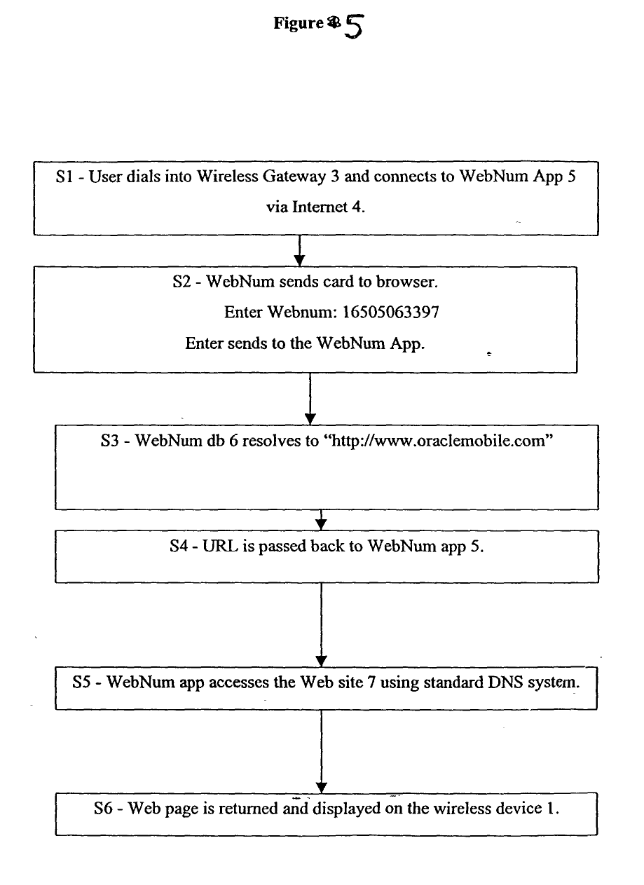

In a preferred embodiment, the Internet circuit 203 supports the WebNum system of private numbers. Referring now to FIGS. 4 and 5, the WebNum system operates as follows. A WebNum entered on the phone 100 is sent from the device to the WebNum application 5 (S1-S2), which runs on a server located at the wireless service provider's gateway 3, or elsewhere on the Internet 4. In this example, the WebNum is 16505063397. The WebNum application 5 can be accessed over a Web site on the Internet and is used to resolve the private number to an URL (S3).

If the phone 100 was produced for a specific provider, the phone may be programmed with an resolution URL belonging to the provider for resolving private numbers into URLs. Alternatively, the phone may be programmed with a resolution URL not belonging to any carrier for resolving private numbers into URLs. Suppose the phone 100 was programmed to use a resolution URL of “http://www.webnum/net/wn/.” The resolution URL may operate by responding to a Web access request consisting of the resolution URL concatenated with the private number. In this example the resolution URL is “http://www.webnum/net/wn” and the private number is 16505063397. Therefore the phone 100 will send a request to “http://www.webnum.net/wn/16505063397,” which will cause the Web server to map the private number 16505063397 to its URL. In this example, private number 16505063397 corresponds to “http://www.oraclemobile.com.” The WebNum application returns this mapping by searching translation tables and databases 6, which may be local to the WebNum application 5, or accessed from a remote location. Thus, the data returned in response to the request will include “http://www.oraclemobile.com.”

The WebNum system will convert the WebNum to an URL or some other Internet identifier, which will point the phone 100 to that resource (S5-S6). The WebNum is sent to the WebNum database server 6 at the wireless carrier or on the Internet, which maps the WebNum back to an URL 7.

The URL includes a field which identifies the access type. In this example, the field contains “http://,” indicating that the access request will be to a the HTTP protocol used to browse web sites. An example of another protocol may include, for example “ftp://,” for the file transfer protocol (FTP). Each well known protocol is associated with one or more TCP/IP port numbers. The HTTP protocol, for example, is associated with port 80. However, Internet services can generally be operated on any port. Thus, the URL also provides a field which is used to specify a specific port. For example, some Web sites operate on port 8080. If in the above example, the Web site operated at port 8080, the URL returned would have been “http://www.oraclemobile.com:8080.” Once the URL has been resolved, the only information required before an access request may be sent to the Internet resource is the TCP/IP address of the Internet resource.

The URL may be translated to a TCP/IP address through traditional DNS lookup mechanisms. When the wireless switch receives the TCP/IP address resolved from its DNS resolution request, the switch creates an TCP/IP datagram, using the protocol specified in the URL, and passes the TCP/IP datagram to an ISP for delivery on the Internet, as illustrated in FIG. 4. The response that comes back from the Internet resource, here Web site 7, displayed on the phone using the appropriate software (e.g., a web browser).

WebNums allow users to access, for example, Web sites supporting of wireless-enabled Web sites quickly and easily by using a simple number to access to the site. The number can be dialed on the keypad of any phone, transferred from the phone's internal phonebook, entered on a wireless handheld device, or entered using a speech recognition function on a phone or other wireless device. The number is translated to an URL through a database at the wireless service provider's gateway applications server, or at an application server located elsewhere on the Internet 4. The URL is resolved through traditional Internet DNS lookup and name resolution mechanisms. The requested data is then returned to the user's phone 100.

WebNums may take several different forms. However, the phone, and the database that maps WebNums to URLs, should preferably treat each of the different forms in the same way. In a preferred embodiment, the general form of a WebNum is:

WebNum<Escape sequence><WebNum extension><Internet>

In this embodiment, the meaning of these fields is:

WebNum—These are the digits of the base or “root” WebNum.

Escape sequence—Escape characters, such as the star key (*) or the pound (#) key, may also be included in the WebNum as an escape sequence. The escape characters are optional, but if used, they indicate the start of different fields within the WebNum. The additional fields are interpreted by the WebNum database resolver.

Internet—The cell phone Internet key 105 indicates the end of the WebNum sequence. Ideally this key is separate from the key used to initiate a telephone conversation (e.g., the Send key 104)

The generalized processing sequence performed by the cell phone system is:

The WebNum in its entirety, except for the terminating <Internet> command, is identified as a string to be sent back to the URL of the WebNum database.

The Internet key 105 indicates that whatever key sequence was entered should be sent the WebNum database 5 for resolution.

The database may interpret the parts of the WebNum differently, depending on how many digits of the number have been entered, and the location, type, and number of escape characters that have been included in the WebNum sequence. The generalized processing sequence performed by the WebNum database 6 is:

The WebNum is mapped to its pre-defined URL entry in the WebNum database 6.

If present, the escape sequence indicates a WebNum extension.

The WebNum extension is an additional numeric sequence that is also mapped to an URL in the database.

The attached appendix includes information of an exemplary commercial implementation of a preferred embodiment.

Other modifications and variations to the invention will be apparent to those skilled in the art from the foregoing disclosure and teachings. Thus, while only certain embodiments of the invention have been specifically described herein, it will be apparent that numerous modifications may be made thereto without departing from the spirit and scope of the invention.

For example, the Internet key can be a soft key, a function under a smart key, hard key, etc. An example of a soft key is an ordinary key on the keypad (e.g., the “5” key”) that is held down for at least a predetermined amount of time (e.g., three seconds) to activate the WebNum functionality for a sequence of characters entered by the user. An example of a function under a smart key is a combination of keys that is depressed (e.g., a “Function” key and then the “*” key) to activate the WebNum functionality for a user-determined private number. An example of a hard key is a key on the keypad that is dedicated to activating webnum functionality.

What is claimed is:

1. An apparatus, including:
a keypad having an I-key;
a processor coupled to said keypad;
a memory coupled to said processor, said memory storing instructions adapted to be executed by said processor to determine a private number based upon a user action, send the private number to a resolution service based upon user activation of the I-key, receive from the resolution service an address of a resource that corresponds to said private number, and send a request for resource information.

2. The apparatus of claim 1, wherein the user action includes selecting an entry from a plurality of entries in a directory.

3. The apparatus of claim 1, wherein said keypad includes a plurality of alphanumeric keys, and wherein the user action includes generating the private number by depressing at least two of said alphanumeric keys.

4. The apparatus of claim 1, wherein the resolution service includes a database that maps the private number to an address corresponding to a resource.

5. The apparatus of claim 1, wherein said apparatus further includes a display, and wherein said instructions are further adapted to be executed by said processor to show the resource information using said display.

6. The apparatus of claim 1, wherein the private number is a WebNum.

7. The apparatus of claim 1, wherein the apparatus includes a microphone, and wherein the user action includes speaking into said microphone.

8. The apparatus of claim 1, wherein the private number is sent to the resolution service indirectly.

9. The apparatus of claim 1, wherein the resource information is received indirectly from the resource.

10. The apparatus of claim 1, wherein the private number includes a plurality of fields separated by at least one escape character.

11. The apparatus of claim 1, wherein the private number includes a first field and a second field, and wherein the first field specifies the address of a gateway specified by a wireless carrier, and wherein the second field specifies data to be resolved by the resolution service.

12. A method, including:
generating a private number based upon a user action;
detecting the activation of an I-key;
sending the private number to a resolution service based upon the activation of the I-key; and
receiving information from a resource whose address corresponds to the private number as determined at the resolution service.

13. The method of claim 12, wherein the private number has two fields, one of said two fields being the address of a resolution service or a gateway, the other of said two fields being data to be resolved into the address of the resource by the resolution service.

14. The method of claim 12, wherein the user action includes depressing at least one key on a keypad.

15. The method of claim 12, wherein the user action includes speaking into a microphone.

16. The method of claim 12, wherein the user action includes selecting an entry from a plurality of stored entries.

17. The method of claim 12, wherein detecting the activation of an I-key includes determining that a key on a keypad has been depressed for at least a predetermined amount of time.

18. The method of claim 12, wherein detecting the activation of an I-key includes determining that a dedicated key on a keypad has been depressed.

19. The method of claim 12, wherein detecting the activation of an I-key includes determining that a predetermined sequence of keys on a keypad have been depressed.

20. The method of claim 12, further including launching a browser.

21. The method of claim 12, wherein the resource is on the Internet.

22. The method of claim 12, further including receiving an address for the resource and sending a request for resource information based upon the received address.

23. A medium storing instructions adapted to be executed by a processor to perform the method including:
generating a private number based upon a user action;
detecting the activation of an I-key;
sending the private number to a resolution service; and
receiving an address based upon the private number.

24. The medium of claim 23 wherein the private number has two fields, one of said two fields being the address of a resolution service or a gateway, the other of said two fields being data to be resolved by the resolution service.

25. The medium of claim 23, wherein detecting the activation of an I-key includes determining that a key on a keypad has been depressed for at least a predetermined amount of time.

26. The medium of claim 23, wherein detecting the activation of an I-key includes determining that a dedicated key on a keypad has been depressed.

27. The medium of claim 23, wherein detecting the activation of an I-key includes determining that a predetermined sequence of keys on a keypad have been depressed.

28. The medium of claim 23, further including instructions to launch a browser.

29. A system, including:
means for generating a private number based upon a user action;
means for detecting the activation of an I-key;
means for sending the private number to be resolved to an address of a resource, based upon the activation of the I-key;
means for obtaining resource information based upon the resolved address; and
means for displaying the resource information.

30. A method, including:
detecting the activation of an I-key;
launching a browser;
accessing a gateway;
identifying a private number to the gateway; and
receiving information from a resource that corresponds to the private number.

31. The method of claim 30, wherein detecting the activation of an I-key includes determining that a key on a keypad has been depressed for at least a predetermined amount of time.

32. The method of claim 30, wherein detecting the activation of an I-key includes determining that a dedicated key on a keypad has been depressed.

33. The method of claim 30, wherein detecting the activation of an I-key includes determining that a predetermined sequence of keys on a keypad have been depressed.

34. The method of claim 30, wherein the number identified to the gateway is a default number.

35. The method of claim 30, wherein the number identified to the gateway is based upon a user action.

36. The method of claim 35, wherein the user action includes selecting an entry from a plurality of entries stored in a directory.

37. The method of claim 35, wherein the user action includes generating the private number by depressing a least two of said alphanumeric keys.

38. The method of claim 35, wherein the user action includes speaking into a microphone.

39. The method of claim 30, wherein the resource is on the Internet.
